(19) United States
(12) Patent Application Publication
(10) Pub. No.: US 2021/0002874 A1
(43) Pub. Date: Jan. 7, 2021

(54) Conduit Connector

(71) Applicant: NORMA Germany GmbH, Maintal (DE)

(72) Inventor: Thomas Petschl, Neuberg (DE)

(21) Appl. No.: 16/977,187

(22) PCT Filed: Feb. 11, 2019
(86) PCT No.: PCT/EP2019/053303

§ 371 Date: Sep. 1, 2020

(30) Foreign Application Priority Data
Mar. 1, 2018 (DE) 10 2018 104 739.8

(51) Int. Cl. E03B 7/10; F16L 51/00

(52) U.S. Cl. CPC E03B 7/10; F16L 57/02; F16L 51/00

(57) ABSTRACT

The disclosure relates to a conduit connector for a fluid line, having a housing, which has at least one first connection geometry and one second connection geometry, each for connecting to a fluid line. In the housing, a fluid-conducting channel is formed between the first connection geometry and the second connection geometry. In order to avoid damage due to freezing of a liquid located in the channel or the connected fluid lines, the housing has a volume equalization device, which is connected to the channel.

### INTRODUCTION

The disclosure relates to a conduit connector for a fluid line, having a housing which has at least one first connection geometry and one second connection geometry, each for connecting to a fluid line, wherein in the housing a fluid-conducting channel is formed between the connection geometries.

Fluid lines for water-containing liquids have to be able to compensate for the increase in volume which occurs when the liquids freeze. In conduits with larger cross sections the resilience of the fluid line is generally sufficient. In the case of smaller cross sections, however, the fluid lines are relatively stiff so that cracks may be produced in the fluid line due to the freezing of the liquid located in the conduit.

In particular, damage occurs in the region of conduit connectors which serve for connecting two or more fluid lines. This is due, amongst other things, to the housing of the conduit connector generally being produced from a relatively inflexible plastics material which is barely able to expand in a resilient manner. Secondly, generally only a small amount of material is available for an expansion of the conduit connector.

A conduit element which has a fluid line which is partially surrounded by an annular housing is disclosed in DE 10 2010 045 714. In this case an outwardly sealed annular space is formed between the fluid line and the housing. The annular space is connected to a conduit interior by an opening. Freezing liquid may thus be diverted through the opening into the annular space and thus reduce stress on the conduit element which arises as a result of the volume increase occurring during freezing. These conduit elements, however, require additional space and generate additional coupling points with the risk of leakages. Moreover, they are not able to prevent damage to the conduit connectors in a reliable manner.

### SUMMARY

An object of the disclosure, per an embodiment, is to provide a conduit connector in which the risk of damage due to the freezing of a liquid located therein is small.

In a conduit connector for a fluid line, having a housing, which has at least one first connection geometry and one second connection geometry, each for connecting to a fluid line line, wherein in the housing a fluid conducting channel is formed between the connection geometries, this object is achieved according to an embodiment of the disclosure in that the housing has a volume equalization device, which is connected to the channel.

The volume equalization device in an embodiment provides a defined space for the freezing liquid into which this liquid is able to be diverted. This space does not necessarily have to be exactly the same size of volume as the volume increase to be anticipated, but may be defined such that even in the case of a complete freezing of the liquid a pressure inside the conduit connector does not rise to such an extent that it might lead to damage of the conduit connector.

In an embodiment, the volume equalization device is configured in a projection protruding outwardly from the housing. This projection thus represents an additional volume in the form of a chamber which may be used for an expansion of the freezing liquid. This solution is advantageous in that, according to at least one embodiment, due to the projection protruding outwardly from the housing, a flow inside the conduit connector is not interrupted. Instead, the space which is present externally around the conduit connector, and which is generally sufficient, is used.

In an embodiment, the volume equalization device has a chamber which is separated from the channel by a flexible fluid-tight membrane. Thus the liquid located in the channel is not able to enter the chamber, so that an internal pressure is reduced and no damage to the conduit connector is to be feared. In this embodiment, when the liquid freezes, a volume equalization takes place only by a corresponding deformation of the membrane which is deformed into the chamber. The external shape of the conduit connector is not altered thereby.

In an embodiment, the membrane is integrated in an insert which is inserted into the chamber. This results in a relatively simple production. Thus the conduit connector may be produced as an injection-molded part from a material which is different from the insert with the flexible membrane. In this embodiment, the entire insert may be correspondingly flexible and in the inserted state bear in a fluid-tight manner against inner faces of the projection. In this embodiment, the membrane may be configured on an inner face of the insert. In this embodiment, the insert is shaped in a cup-shaped manner, for example, wherein the membrane forms a base. Thus sufficient space for a deformation of the membrane is available, wherein the sides bear flat against the inner faces of the projection. Thus a high level of tightness is achieved.

In an embodiment, the chamber is configured inside the insert. Thus the chamber has a precisely defined sealed volume which, for example, is filled with air. This air is then compressed when the membrane which defines the chamber on one side is deformed, and represents a gradual counter force.

In an embodiment, a compressible element is arranged in the projection. Thus pressure may be applied to this element by liquid located in the channel. When the volume of the liquid increases, in particular when the liquid freezes, the element is compressed and thus reduces the pressure which is exerted by the liquid onto the conduit connector. In this case, the element seals the projection outwardly so that an escape of liquid from the channel is prevented by the projection.

In this embodiment, the element has a closed-pore foamed material. Thus the element itself is not able to absorb any liquid, so that it may be ensured that when the liquid freezes the element is not damaged but merely compressed.

In a further embodiment, the volume equalization device is configured as a cylindrical element which is arranged coaxially in the channel. The external shape of the conduit connector is thus kept unaltered and this also permits use in confined conditions. In this embodiment, a volume equalization is carried out by compressing the cylindrical element. In this embodiment, by a corresponding length and material thickness of the cylindrical element a sufficient volume reduction may be achieved and thus compensate for the increase in volume of the freezing liquid.

In this embodiment, the cylindrical element has a closed-pore foamed material. The closed-pore foamed material has the advantage, per an embodiment, that it is relatively inexpensive and also absorbs no liquid. Thus, when the liquid freezes, the closed-pore foamed material is not damaged but merely resiliently deformed.

The conduit connector may be configured in different ways. According to an embodiment, the first connection geometry is configured as an insert connector and the second connection geometry is configured as a connector receiver, wherein the volume equalization device is arranged closer to the first connection geometry than to the second connection geometry. It has been shown that damage to the conduit connector frequently occurs in the region of the insert connector. This is taken into account by arranging the volume equalization device in the region of the insert connector. In this embodiment, naturally care is taken that the insert connector is able to be inserted sufficiently far into a fluid line.

In an embodiment of the conduit connector it is provided that the housing has a third connection geometry, wherein at a branching a further channel branches off to the third connection geometry from the channel between the first connection geometry and the second connection geometry. Such a conduit connector which, for example, is configured to be T-shaped or Y-shaped, permits the connection of two fluid lines to a supply line. By the arrangement of the volume equalization device in the region of the branching, this not only at least partially compensates for an increase in the volume of the liquid inside the channel but also inside the further channel. In this embodiment, the volume equalization device is configured in a projection which extends outwardly from the housing in the region of the branching. In this embodiment, the projection may be located in one plane with the connecting geometries, which may be advantageous in a T-shaped connector, wherein the projection is located, in particular, in the axial extension of a channel. Alternatively, however, the projection may also be oriented perpendicular to the plane in which the connection geometries are located. This may be advantageous primarily for a Y-shaped connector.

In principle, the conduit connector may be used for fluid lines. The conduit connector appears to be suitable, however, for water-containing liquids, such as coolants, or even in connection with heatable fluid lines as are used, for example, in motor vehicles for urea lines. A further use is supply lines for water injection in motor vehicle engines.

Further features, details and advantages of the disclosure are disclosed in the wording of the claims and in the following description of exemplary embodiments, with reference to the drawings, in which:

### BRIEF DESCRIPTION OF THE FIGURES

FIG. 1 shows a cross section through a conduit connector of a first embodiment,

FIGS. 2a-2c show different embodiments of an insert,

FIG. 3 shows a cross section through a conduit connector of a second embodiment and

FIG. 4 shows a cross section through a conduit connector of a third embodiment.

### DETAILED DESCRIPTION

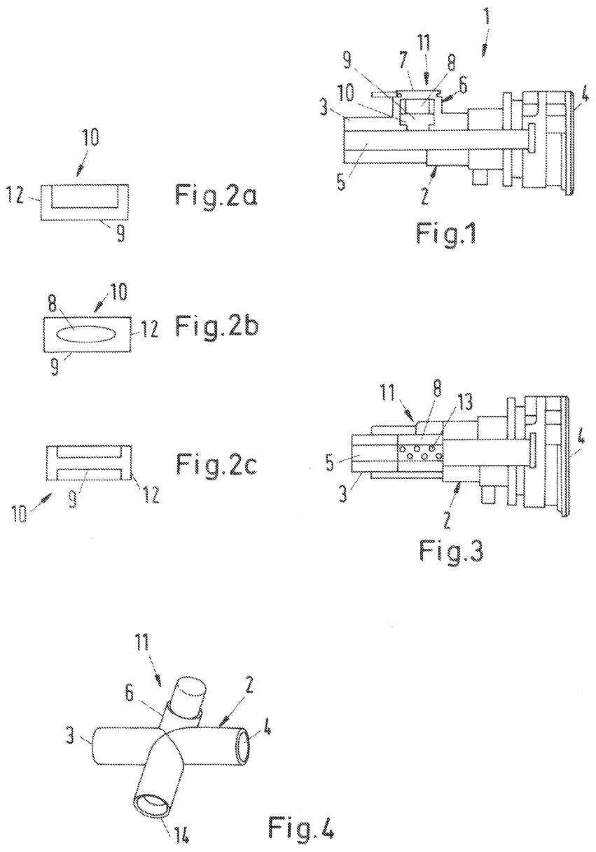

A conduit connector 1 which has a housing 2 with a first connection geometry 3 and a second connection geometry 4 is shown in FIG. 1. In the housing 2, a channel 5 is formed between the first connection geometry 3 and the second connection geometry 4. In this case, the first connection geometry 3 is configured as an insert connector and the second connection geometry 4 is configured as a connector receiver. A projection 6 which protrudes outwardly from the housing 2 is formed in the region of the first connection geometry 3. In this case, a through-passage is formed in the housing 2 between the channel 5 and an interior of the projection 6.

The projection 6 and/or the chamber 8 is closed outwardly by a cover 7 which, in particular, is welded and thus is pressure-tight. Thus a chamber 8 which is connected to the channel 5 at least in a pressure-transmitting manner via the through-passage is formed in the interior of the projection 6.

A penetration of liquid from the channel 5 into the chamber 8 is prevented in this case by a flexible fluid-tight membrane 9, which in this embodiment is integrated in an insert 10.

When the volume of the liquid in the channel 5 increases, for example during freezing, the membrane 9 bulges into the chamber 8 and thus reduces a pressure acting on the housing 2. The insert 10 which is inserted in the projection 6 thus forms with the chamber 8 a volume equalization device 11.

Different variants of an insert 10 are shown in FIGS. 2a, 2b and 2c. The variant in FIG. 2a corresponds in this case to the insert 10, as used in the embodiment according to FIG. 1. In this case, the insert 10 is cup-shaped, wherein the membrane 9 constitutes a base of the insert 10. Annular side walls 12 extend therefrom and when inserted in the projection 6 bear sealingly against inner faces of the projection 6. This results in a fluid-tight and pressure-tight connection, wherein the through-passage to the channel 5 is covered by the membrane 9 on the base of the insert 10.

FIG. 2b shows a variant of the insert 10 in which the chamber 8 is configured as a closed volume inside the insert 10. When pressure is applied to the membrane 9, said membrane is deformed into the chamber 8 and thus reduces a pressure inside the conduit connector 1.

A further variant of the insert 10 is shown in FIG. 2c in which the insert 10 has an H-shaped cross section. In contrast to the variant according to FIG. 2a, the membrane 9 is not arranged at the ends of the side walls 12 but approximately centrally.

FIG. 3 shows a conduit connector 1 with an alternative embodiment of the volume equalization device 11. The volume equalization device 11 in this case comprises a cylindrical element 13 which is arranged coaxially in the channel 5. In this case, the housing 2 of the conduit connector 1 is designed such that an annular space which represents the chamber 8 is formed around the cylindrical element 13. The chamber 8 is thus separated by the cylindrical element 13 from the channel 5.

The cylindrical element 13 is produced, for example, from a closed-pore foamed material which does not absorb any water. When liquid freezes in the conduit connector 1 and/or in the channel 5, this liquid expands, whereby the cylindrical element 13 is deformed into the chamber 8. As a result, a pressure acting on the conduit connector 1 is reduced.

The remaining configuration of the conduit connector 1 corresponds to the embodiment according to FIG. 1, wherein a projection is not required, however. From the outside the volume equalization device 11 is not able to be identified, but rather the conduit connector 1 maintains its external shape.

In FIG. 4 is an embodiment of the conduit connector 1 the time which in addition to the first connection geometry 3 and the second connection geometry 4 has a third connection geometry 14. Such a T-shaped year conduit connector 1 serves, for example, for dividing a fluid line into two further fluid lines. To this end, a further channel, which is connected in a fluid-conducting manner via the branching to the channel 5 formed between the first connection geometry 3 and the second connection geometry 4, branches off at a branching in the interior of the housing 2.

In the region of the branching the conduit connector 1 has a projection 6 in which a volume equalization device 11 is arranged. The volume equalization device 11 corresponds in its configuration, in particular, to the volume equalization device 11 as shown in FIG. 1. In particular, an insert 10 as shown in FIGS. 2a to 2c is also received in the projection 6. The volume equalization device 11 is thus connected both to the channel between the first connection geometry 3 and the second connection geometry 4 and to the further channel between the branching and third connection geometry 14.

The invention is not limited to one of the above-described embodiments but may be modified in many different ways. Thus, in particular, the shape of the conduit connector may deviate from the shape shown. Moreover, additional elements may be provided, such as for example heating elements wound outside around the fluid line and/or the conduit connector. These elements serve, therefore, for rapid thawing of a liquid located in the conduit connector and/or the fluid lines, as is required for example in motor vehicles with urea injection.

All of the features and advantages disclosed in the claims, the description and the drawing, including structural details, spatial arrangements and method steps, may be essential to the invention both per se and in very different combinations.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE NUMERALS

1 Conduit connector
2 Housing
3 First connection geometry
4 Second connection geometry
5 Channel
6 Projection
7 Cover
8 Chamber
9 Membrane
10 Insert
11 Volume equalization device
12 Side walls
13 Cylindrical element
14 Third connection geometry

1. A conduit connector for a fluid line comprising a housing, which has at least one first connection geometry and one second connection geometry, each for connecting to a fluid line, wherein in the housing a fluid-conducting channel is formed between the first connection geometry and the second connection geometry, wherein the housing has a volume equalization device, which is connected to the fluid-conducting channel.

2. The conduit connector as claimed in claim 1, wherein the volume equalization device is configured in a projection protruding outwardly from the housing.

3. The conduit connector as claimed in claim 1, wherein the volume equalization device has a chamber which is separated from the fluid-conducting channel by a flexible fluid-tight membrane.

4. The conduit connector as claimed in claim 3, wherein the flexible fluid-tight membrane is integrated in an insert which is inserted in a projection protruding outwardly from the housing.

5. The conduit connector as claimed in claim 4, wherein the chamber is configured inside the insert.

6. The conduit connector as claimed in claim 2, wherein a compressible element is arranged in the projection.

7. The conduit connector as claimed in claim 6, wherein the compressible element has a closed-pore foamed material.

8. The conduit connector as claimed in claim 1, wherein the volume equalization device is configured as a cylindrical element which is arranged coaxially in the fluid-conducting channel.

9. The conduit connector as claimed in claim 8, wherein the cylindrical element has a closed-pore foamed material.

10. The conduit connector as claimed in claim 1, wherein the first connection geometry is configured as an insert connector and the second connection geometry is configured as a connector receiver, wherein the volume equalization device is arranged closer to the first connection geometry than to the second connection geometry.

11. The conduit connector as claimed in claim 1, wherein the housing has a third connection geometry, wherein at a branching a further channel branches off to the third connection geometry from the fluid-conducting channel between the first connection geometry and the second connection geometry.

12. The conduit connector as claimed in claim 11, wherein the volume equalization device is arranged in a region of the branching.
